(19) United States
(12) Patent Application Publication
(10) Pub. No.: US 2026/0200436 A1
(43) Pub. Date: Jul. 16, 2026

(54) WIPING DEVICE

(71) Applicant: MITSUBA Corporation, Gunma (JP)

(72) Inventor: TOSHIYUKI AMAGASA, Gunma (JP)

(73) Assignee: MITSUBA Corporation, Gunma (JP)

(21) Appl. No.: 18/878,916

(22) PCT Filed: Mar. 21, 2024
(86) PCT No.: PCT/JP2024/010900

§ 371 Date: Dec. 26, 2024

(30) Foreign Application Priority Data
Mar. 22, 2023 (JP) 2023-045644

(51) Int. Cl. B60S 1/08

(52) U.S. Cl. CPC B60S 1/0822; B60S 1/0814

(57) ABSTRACT

A wiping device wipes rainwater on a surface to be wiped by causing a wiper blade to perform reciprocating motion using a predetermined power source, and includes a power source drive unit that sets a wiping range of a heavy rain mode to be narrower than a wiping range of a normal mode, and sets the wiping range of the heavy rain mode to a minimum wiping area specified by regulations.

### TECHNICAL FIELD

The present invention relates to a wiping device.

### RELATED ART

Patent Literature 1 below discloses a wiper system control device. This wiper system control device is a control device that performs operation control of a vehicle wiper system including a wiper blade that performs reciprocating wiping motion on a wiping surface, and a rain drop sensor that detects the current rainfall amount based on water droplets adhering to the wiping surface. The wiper blade includes a driver's seat side wiper blade configured on the driver's seat side of the vehicle and a passenger seat side wiper blade configured on the passenger seat side of the vehicle. The driver's seat side wiper blade is driven by a first electric motor, and the passenger seat side wiper blade is driven by a second electric motor provided separately from the first electric motor. The control device is connected via a communication line to a first wiper control device that controls the drive of the first electric motor and has a second wiper control device that controls the drive of the second electric motor. The first electric motor and the second electric motor are synchronously controlled by the first and second control devices based on the position information of both the driver's seat side wiper blade and the passenger seat side wiper blade. A heavy rain wiping area, which is narrower than the normal wiping range of the driver's seat side wiper blade, is set near the driver's forward visibility area on the wiping surface. The first and second control devices include a rainfall state determination unit that determines a current rainfall state based on an output signal of the rain drop sensor, and an operation mode change unit that, in the case where the rainfall state determination unit determines that the rainfall amount is equal to or greater than a predetermined value and is in a heavy rain state, narrows the wiping range of the driver's seat side wiper blade compared to the normal wiping operation, and changes the operation mode of the wiper blade to a heavy rain mode that operates the driver's seat side wiper blade at high speed only within the heavy rain wiping area.

### CITATION LIST

### Patent Literature

Patent Literature 1: Japanese Patent No. 6349120

### SUMMARY

### Technical Problem

Incidentally, although the wiping speed of the Hi operation of the wiping device corresponding to heavy rain, etc., differs depending on the vehicle manufacturer and model of the vehicle, one of the factors for this difference may be due to load condition constraints such as differences in the length of the wiper arm and wiper blade, and the maximum voltage of the drive motor. In wiping devices with high loads, such as those with 4-link arms or long blades, in order to increase the rotation number of the Hi operation, it is necessary to use a drive motor with a larger rating and apply a large current.

On the other hand, as vehicle electrification progresses, reducing power consumption in wiping devices has become an important theme, and securing visibility during heavy rain, which is increasing due to recent abnormal weather conditions, has become an issue that vehicle manufacturers should address. That is, the requirements for wiping devices in response to heavy rain are contradictory from the perspective of power consumption. To meet these requirements, it is necessary to achieve wiping that responds to heavy rain without increasing the power consumption of the wiping device.

The present invention has been made in view of the above-mentioned circumstances, and its objective is to provide a wiping device capable of achieving wiping that responds to heavy rain without increasing power consumption.

### Solution to Problem

To achieve the above objective, the present invention adopts, as a first solution method related to the wiping device, a means including: a wiping device that wipes rainwater on a surface to be wiped by causing a wiper blade to perform reciprocating motion using a predetermined power source, the wiping device including: a power source drive unit, setting a wiping range of a heavy rain mode to be narrower than a wiping range of a normal mode, and setting the wiping range of the heavy rain mode to a minimum wiping area specified by regulations.

The present invention adopts, as a second solution method related to the wiping device, in addition to the first solution method, a means wherein the power source drive unit switches an operation mode from the normal mode to the heavy rain mode based on a switch signal of a mist switch provided in a vehicle.

The present invention adopts, as a third solution method related to the wiping device, in addition to the second solution method, a means wherein the power source drive unit switches the operation mode from the normal mode to the heavy rain mode based on a length of an ON time of the mist switch.

The present invention adopts, as a fourth solution method related to the wiping device, in addition to the third solution method, a means wherein the power source drive unit switches from the normal mode to the heavy rain mode in a case where the ON time is equal to or greater than a predetermined threshold value.

The present invention adopts, as a fifth solution method related to the wiping device, in addition to any of the first to third solution methods, a means wherein the power source is provided as one or two, where one power source causes one or a pair of the wiper blades to perform reciprocating motion, and two power sources individually cause a pair of the wiper blades to reciprocating motion.

### Effects of Invention

According to the present invention, it is possible to provide a wiping device capable of achieving wiping that responds to heavy rain without increasing power consumption.

### BRIEF DESCRIPTION OF DRAWINGS

FIG. 1 is a block diagram showing the functional configuration of the wiping device A according to the first embodiment of the present invention.

FIG. 2 is a flowchart showing the operation of the wiping device A according to the first embodiment of the present invention.

FIG. 3 is a timing chart showing the operation of the wiping device A according to the first embodiment of the present invention.

FIG. 4 is a schematic diagram showing the wiping range (minimum wiping area) in the first embodiment of the present invention.

FIG. 5 is a flowchart showing the operation mode switching process in the first embodiment of the present invention.

FIG. 6 is a block diagram showing the functional configuration of the wiping device A according to the second embodiment of the present invention.

### DESCRIPTION OF EMBODIMENTS

### First Embodiment

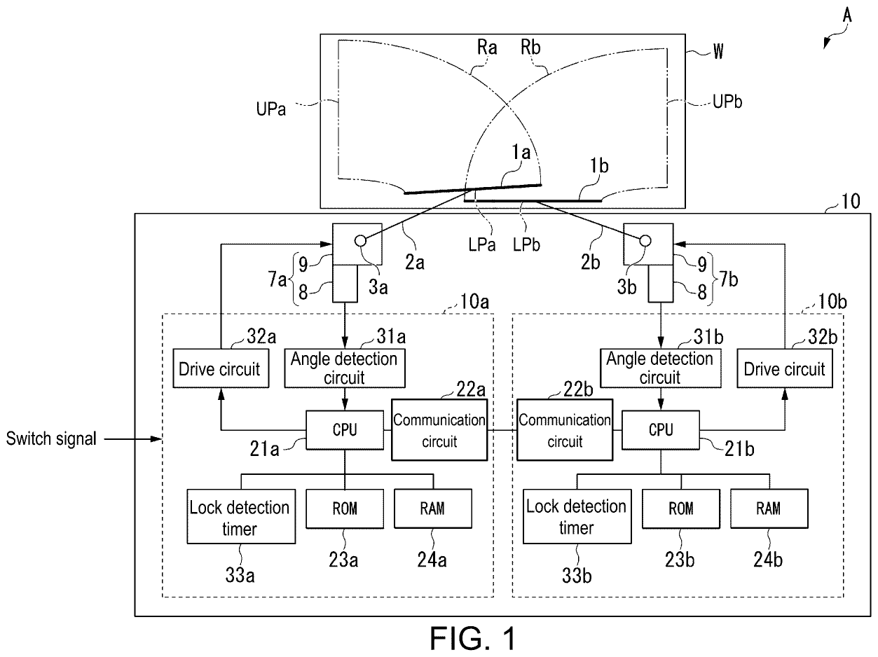

First, the first embodiment of the present invention will be described with reference to FIG. 1 to 5. The wiping device A according to the first embodiment is mounted on various types of vehicles and is a device that wipes rainwater off the surface (surface to be wiped) of the windshield rear window.

This wiping device A, as shown in FIG. 1, adopts a dual motor drive system that individually drives a pair of wiper blades 1a and 1b with a pair of motors 7a and 7b as power sources. That is, the wiping device A according to the first embodiment is provided with two power sources, and the two power sources reciprocate a pair of wiper blades 1a and 1b individually. In the wiping device A according to the first embodiment, it is preferable to use brushless wiper motors for both of the pair of motors 7a and 7b. In the operation of the heavy rain mode, when repeatedly rotating the brushless wiper motors at high speed in forward and reverse directions, there is no generation of brush wear powder due to the sliding of brushes and commutators as in brush-type wiper motors, thereby extending the life of the wiper motor. Further, by using brushless wiper motors, smooth repetition of forward and reverse rotations may be achieved, enabling precise inversion at the top reverse position and bottom reverse position set for the heavy rain mode.

This wiping device A, as shown in the figures, includes a pair of wiper blades 1a and 1b and a single drive mechanism 10. It is noted that in the reference numerals in FIG. 1, “a” indicates components or parts related to the driver's seat side of the vehicle. Further, “b” indicates components or parts related to the passenger seat side of the vehicle.

The pair of wiper blades 1a and 1b are rod-shaped members positioned on the windshield W as shown. The pair of wiper blades 1a and 1b are in contact with the surface of the windshield W (surface to be wiped), and wipe off rainwater existing on the surface to be wiped by performing reciprocating motion (swinging motion) on the surface to be wiped.

It is noted that, in FIG. 1, the symbol Ra indicates the wiping range of the driver's seat side wiper blade 1a when the operation mode of the drive mechanism 10 is set to normal mode. Further, the symbol Rb indicates the wiping range of the passenger seat side wiper blade 1b when the operation mode of the drive mechanism 10 is set to normal mode.

The pair of wiper blades 1a and 1b are mechanically connected to the drive mechanism 10 through a pair of wiper arms 2a and 2b. That is, the driver's seat side wiper blade 1a is connected to the drive mechanism 10 through the wiper arm 2a provided on the driver's seat side. The passenger seat side wiper blade 1b is connected to the drive mechanism 10 through the wiper arm 2b provided on the passenger seat side.

The pair of wiper arms 2a and 2b are rod-shaped members as shown in the figure, with one end connected to the middle portion of the pair of wiper blades 1a and 1b, and the other end connected to a pair of wiper shafts 3a and 3b. That is, the driver's seat side wiper arm 2a has one end connected to the middle portion of the driver's seat side wiper blade 1a, and the other end connected to the driver's seat side wiper shaft 3a.

On the other hand, the passenger seat side wiper arm 2b has one end connected to the middle portion of the passenger seat side wiper blade 1b, and the other end connected to the passenger seat side wiper shaft 3b. It is noted that this pair of wiper arms 2a and 2b are members included in the components of the pair of wiper blades 1a and 1b.

The pair of wiper arms 2a and 2b function as power transmission components that mechanically transmit the rotational power of the drive mechanism 10 to the pair of wiper blades 1a and 1b. Further, the pair of wiper arms 2a and 2b function as biasing members that press the pair of wiper blades 1a and 1b against the surface of the windshield W (surface to be wiped) with a predetermined pressing force.

The drive mechanism 10 is a power generating device that causes the pair of wiper blades 1a and 1b to perform reciprocating motion through the pair of wiper arms 2a and 2b. This drive mechanism 10 causes the pair of wiper blades 1a and 1b placed on the surface of the windshield W (surface to be wiped) to perform reciprocating motion by rotating the pair of wiper shafts 3a and 3b within a predetermined angular range.

The drive mechanism 10 includes a pair of motors 7a and 7b as power sources corresponding to the pair of wiper shafts 3a and 3b. The pair of motors 7a and 7b each include a motor body 8 and a speed reduction mechanism 9. Further, the drive mechanism 10 includes a pair of wiper controllers 10a and 10b corresponding to the pair of motors 7a and 7b.

The pair of wiper controllers 10a and 10b are power source drive units that drive the pair of motors 7a and 7b, which serve as power sources. The driver's seat side motor 7a, when drive-controlled by the wiper controller 10a, causes the driver's seat side wiper blade 1a to perform reciprocating motion (swinging motion) on the surface to be wiped. The passenger seat side motor 7b, when drive-controlled by the wiper controller 10b, causes the passenger seat side wiper blade 1b to perform reciprocating motion (swinging motion) on the surface to be wiped.

The wiper controller 10a corresponding to the driver's seat side is composed of a control board consisting of electronic circuits including a CPU (central processing unit) 21a, a communication circuit 22a, a ROM (read only memory) 23a, a RAM (random access memory) 24a, an angle detection circuit 31a, a drive circuit 32a, and a lock detection timer 33a, and is built into the speed reduction mechanism 9 of the motor 7a. Further, the wiper controller 10b corresponding to the passenger seat side is composed of a control board consisting of electronic circuits including a CPU 21b, a communication circuit 22a, a ROM 23b, a RAM 24b, an angle detection circuit 31b, a drive circuit 32b, and a lock detection timer 33b, and is built into the speed reduction mechanism 9 of the motor 7b.

The wiper controller 10a corresponding to the driver's seat side and the wiper controller 10b corresponding to the passenger seat side are connected for communication through the pair of communication circuits 22a and 22b. Further, the wiper controller 10a that drive-controls the driver's seat side motor 7a is connected to the ECU, which is the host controller of the vehicle, via a communication line. The wiper controller 10a receives switch signals from the ECU, including the ON/OFF status of the wiper switch, heavy rain mode designation, ON/OFF status of the mist switch, and intermittent operation (Lo wiping, Hi wiping, INT wiping).

In the drive mechanism 10, the pair of motors 7a and 7b are feedback-controlled based on the elapsed time from an absolute position that serves as a control reference, and the positions of the pair of wiper blades 1a and 1b are controlled. In this position control, the bottom reverse positions LPa and LPb are used as the absolute positions, and corresponding to the elapsed time t from the bottom reverse positions LPa and LPb, the target rotation number TR of the pair of motors 7a and 7b at that time point is predetermined by an operation map.

Here, the drive mechanism 10 has two operation modes: normal mode and heavy rain mode. In the normal mode, the wiper controller 10a performs wiping control including low-speed wiping (Lo wiping) at a predetermined speed, high-speed wiping (Hi wiping) faster than the low-speed wiping, and intermittent wiping (INT wiping) that repeats wiping control that performs low-speed wiping after a predetermined time has elapsed; in the heavy rain mode, the wiper controller 10a controls the wiper motor 7a to repeatedly rotate forward and backward at a speed faster than the high-speed wiping, performing wiping control by reciprocating within the narrow wiping range NRa described later. That is, the operation map includes a heavy rain mode operation map applied in the case of the heavy rain mode, and a normal mode operation map applied in the case of operation modes other than the heavy rain mode. These operation maps are stored in each of the pair of ROMs 23a and 23b. The heavy rain mode operation map has target rotation numbers TR set differently from the target rotation numbers TR in the normal mode operation map. It is noted that the concept of heavy rain in the present invention includes localized intense heavy rain that falls in a short time (guerrilla heavy rain).

The pair of wiper controllers 10a and 10b measure the elapsed time t from the bottom reverse positions LPa and LPb in the pair of CPUs 21a and 21b, grasp the current rotation number of the pair of motors 7a and 7b, and also compare the current rotation number at the elapsed time t with the target rotation number TR. The pair of CPUs 21a and 21b indirectly control the pair of motors 7a and 7b by directly controlling the pair of drive circuits 32a and 32b according to the between the current rotation number and the target rotation number TR.

Between the pair of motors 7a and 7b and the pair of CPUs 21a and 21b, a pair of angle detection circuits 31a and 31b are provided to detect the positions of the pair of wiper blades 1a and 1b. The pair of angle detection circuits 31a and 31b output relative position signals which are proportional to the motor rotation angles of the pair of motors 7a and 7b and which indicate the amount of movement of the pair of wiper blades 1a. Further, the pair of angle detection circuits 31a and 31b output absolute position signals indicating the position of a specific wiper blade among the pair of wiper blades 1a and 1b.

That is, the angle detection circuit 31a corresponding to the driver's seat side is provided between the driver's seat side motor 7a and the CPU 21a corresponding to the driver's seat side. This angle detection circuit 31a outputs a relative position signal that is proportional to the motor rotation angle of the motor 7a on the driver's seat side and indicates the amount of movement of the driver's seat side wiper blade 1a, and an absolute position signal that indicates the position of a specific wiper blade.

The angle detection circuit 31b corresponding to the passenger seat side is provided between the passenger seat side motor 7b and the CPU 21b corresponding to the passenger seat side. This angle detection circuit 31b outputs a relative position signal that is proportional to the motor rotation angle of the passenger seat side motor 7b and indicates the amount of movement of the passenger seat side wiper blade 1b, and an absolute position signal that indicates the position of a specific wiper blade.

The relative position signal is a pulse signal (motor pulse) generated in response to the rotation of the pair of motors 7a and 7b. This relative position signal is a pulse signal with a number of pulses proportional to the rotation angle of the pair of motors 7a and 7b. The absolute position signal is a single signal emitted when the pair of wiper blades 1a and 1b reach the control reference position (for example, the bottom reverse positions LPa and LPb).

The rotation number of the pair of motors 7a and 7b and the rotation number of the pair of wiper shafts 3a and 3b have a constant relationship based on the reduction ratio of the speed reduction mechanism 9. The rotation angle of the pair of wiper shafts 3a and 3b may be obtained by calculation based on the number of pulses in the relative position signal. Further, the rotation angle of the pair of wiper shafts 3a and 3b and the movement angle of the pair of wiper blades 1a and 1b have a constant relationship.

That is, it is possible to detect the movement angle of the pair of wiper blades 1a and 1b by accumulating the number of pulses in the relative position signal. The pair of CPUs 21a and 21b detect the current position of the pair of wiper blades 1a and 1b based on the combination of the accumulated result of the number of pulses in the relative position signal and the absolute position signal. Further, the pair of CPUs 21a detect the current motor rotation number of the pair of motors 7a and 7b by counting the relative position signals (motor pulses).

The pair of CPUs 21a and 21b measure the elapsed time t from the acquisition time of the absolute position signal using their built-in timers. Further, the pair of CPUs 21a and 21b obtain the target position of the pair of wiper blades 1a and 1b and the target rotation number TR of the pair of motors 7a and 7b for the current elapsed time from the ROMs 23a and 23b.

The pair of CPUs 21a and 21b compare the current position of the pair of wiper blades 1a and 1b with their target position, and grasp the current situation of the pair of wiper blades 1a and 1b (the degree of delay or advance relative to the target position). Further, the pair of CPUs 21a and 21b calculate the rotation number of the pair of motors 7a and 7b based on the status of the rotation number of the pair of motors 7a and 7b (high or low relative to the target rotation number TR), and control the rotation of the pair of motors 7a and 7b based on the calculated rotation number.

That is, the pair of ROMs 23a and 23b have pre-stored operation maps that include the target values for the position of the pair of wiper blades 1a and 1b and the motor rotation number of the pair of motors 7a and 7b, with the elapsed time t from the acquisition time of the absolute position signal as a parameter. The pair of CPUs 21a and 21b perform feedback control of the pair of motors 7a and 7b by comparing the target values of the motor rotation number in such operation maps with the current values.

Further, in each operation map, the preceding relationship of the pair of wiper blades 1a and 1b is set in advance. Furthermore, in each operation map, the target rotation number TR is determined according to the position of the counterpart based on the elapsed time t from the acquisition time of the absolute position signal and the current position of the pair of wiper blades 1a and 1b. For example, even if the elapsed time t and the current position of the pair of wiper blades 1a and 1b are the same, the target rotation number TR is set to be larger in the case where the current position of the counterpart is close to itself, and the target rotation number TR is set to be smaller in the case where the current position of the counterpart is farther from itself.

The current positions of the pair of wiper blades 1a and 1b are exchanged between the pair of CPUs 21a and 21b through the pair of communication circuits 22a and 22b, and are written into the pair of RAMs 24a and 24b. The pair of CPUs 21a and 21b synchronously control the pair of motors 7a and 7b based on the positional relationship of the pair of wiper blades 1a and 1b written in the pair of RAMs 24a and 24b.

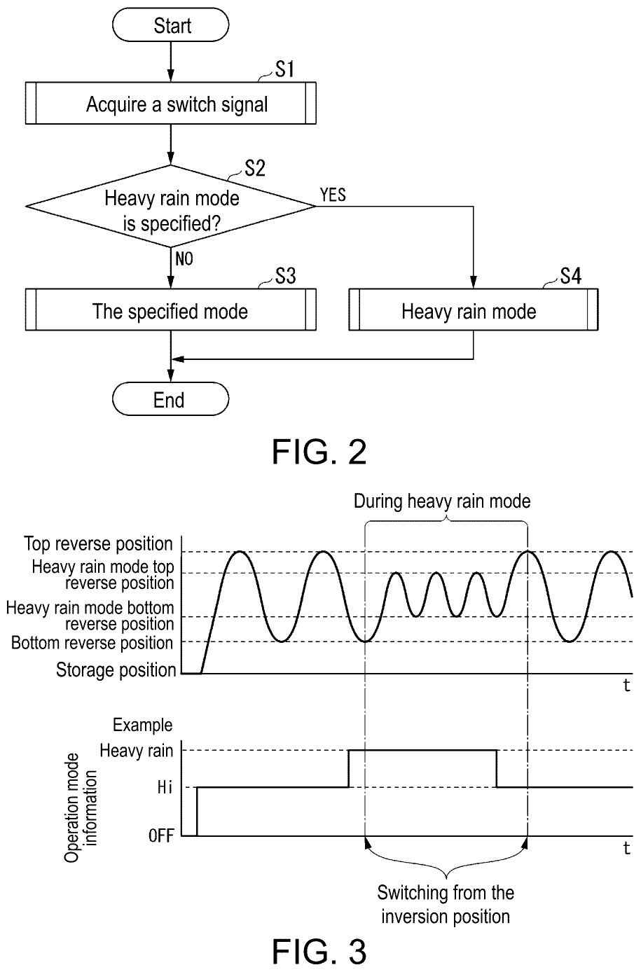

Next, the characteristic operation of the wiping device A according to the first embodiment is described along with the flowchart shown in FIG. 2.

The CPU 21a of the wiper controller 10a acquires a switch signal at a predetermined timing through communication with the ECU, which is the host controller (Step S1). The CPU 21a determines whether the switch signal specifies the heavy rain mode as the operation mode (Step S2). In the case where the determination in Step S2 is “No”, that is, in the case where the switch signal does not specify the heavy rain mode, the CPU 21a maintains the operation mode as the normal mode (Step S3).

That is, the pair of CPUs 21a and 21b perform feedback control of the pair of motors 7a and 7b based on the operation map for normal mode, similar to before receiving the switch signal. It is noted that the storage position is set on the engine room side relative to the bottom reverse positions LPa and LPb, and when the pair of motors 7a and 7b are not in use, each wiper blade is set to a position where it is less visible from inside the vehicle.

On the other hand, in the case where the determination in Step S2 is “Yes”, that is, in the case where the switch signal specifies the heavy rain mode, the CPU 21a switches the operation mode from the normal mode to the heavy rain mode (Step S4). Then, the pair of CPUs 21a and 21b perform feedback control of the pair of motors 7a and 7b based on the operation map for heavy rain mode instead of the operation map for normal mode. In the case of switching from the state of wiping in normal mode to heavy rain mode, after moving the pair of wiper blades 1a and 1b to the top reverse positions UPa and UPb, or the bottom reverse positions LPa and LPb, only one motor 7a is driven to invert the wiper blade 1a towards the bottom reverse position NLP or the top reverse position NUP of the narrow wiping range NRa, and perform reciprocating motion wiping in the narrow wiping range NRa. The other motor 7b may not only stop the wiper blade 1b at a position that does not interfere with the wiper blade 1a, such as the bottom reverse position LPb, the storage position, or the top reverse position UPb, but may also perform reciprocating motion wiping of the wiper blade 1b in the range between the narrow wiping range NRa and the top reverse position UPb, which does not interfere with the wiper blade 1a.

The feedback control of one motor 7a based on this operation map for heavy rain mode, as shown in FIG. 3, sets the bottom reverse position NLP of one wiper blade 1a higher than the bottom reverse position LPa of the normal mode, and sets the top reverse position NUP of one wiper blade 1a lower than the top reverse position UPa of the normal mode.

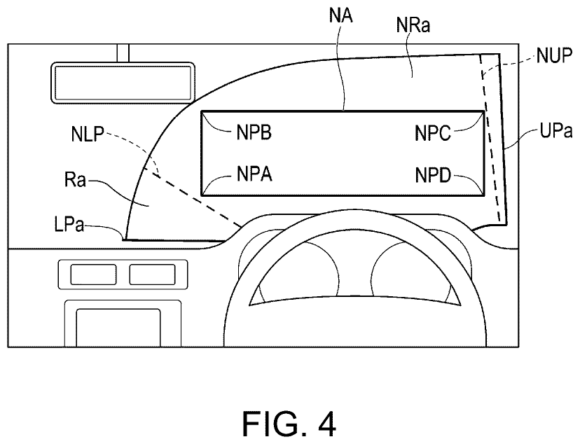

That is, the wiping range (movement range) NRa of one wiper blade 1a in the heavy rain mode is set narrower than the wiping ranges Ra and Rb (movement ranges) of the pair of wiper blades 1a and 1b in the normal mode. Furthermore, as shown in FIG. 4, the wiping range (movement range) NRa in the heavy rain mode is set to include at least the “minimum wiping area” of the forward visibility as specified by regulations.

Here, the “minimum wiping area” refers to a virtual range having four setting positions defined by regulations, corresponding to the “Area A” in the wiping area regulations on the surface to be wiped of Japanese and European Economic Community (EEC) regulations, or the “Area C” in the wiping area regulations of the United States Federal Motor Vehicle Safety Standards (FMVSS) regulations regulations.

According to this first embodiment, it is possible to satisfy the “minimum wiping area” of forward visibility specified by regulations during heavy rain. As shown in FIG. 4, the minimum wiping area NA wiped in the heavy rain mode is defined as follows: the position where one wiper blade 1a first overlaps with the minimum wiping area NA when moving from the normal bottom reverse position LPa towards the minimum wiping area NA is set as the first lower side setting position NPA; the position adjacent to the first lower side setting position NPA in the top and bottom direction and set closer to the normal bottom reverse position LPa within the minimum wiping area NA is set as the second lower side setting position NPB; the position where one wiper blade 1a first overlaps with the minimum wiping area NA when moving from the normal top reverse position UPa towards the minimum wiping area NA is set as the first upper side setting position NPC; and the position adjacent to the first upper side setting position NPC in the top and bottom direction and set closer to the normal top reverse position UPa is set as the second upper side setting position NPD. The range between the first lower side setting position NPA and the first upper side setting position NPC is defined as the narrow wiping range NRa, and by performing high-speed rotation and forward-reverse rotation control using a brushless wiper motor in the narrow wiping range NRa during the heavy rain mode, it is possible to wipe the “minimum wiping area” of the driver's forward visibility. Further, according to the first embodiment, since the range of movement in the narrow wiping range NRa during the heavy rain mode is narrower than the range of movement in the wiping ranges Ra and Rb during the normal mode, it is possible to achieve power saving in the wiping device A.

That is, in the first embodiment, the narrow wiping range NRa of one wiper blade 1a during heavy rain is limited to the “minimum wiping area” of forward visibility, which is narrower than the range of movement in the wiping ranges Ra and Rb in the normal mode. Thus, according to the first embodiment, it is possible to provide a wiping device A capable of achieving wiping suitable for heavy rain conditions without increasing power consumption.

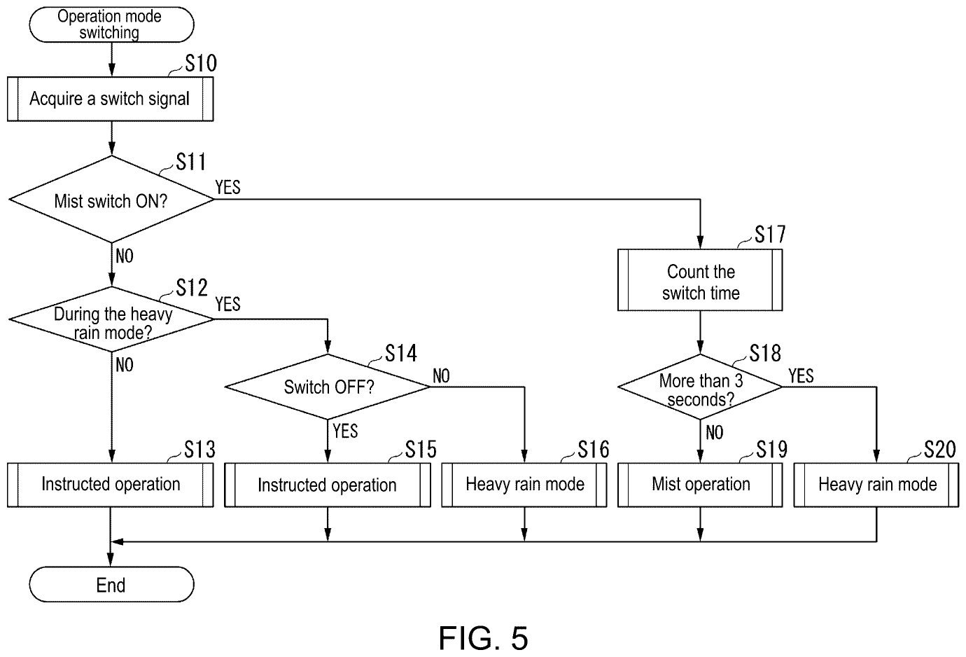

Further, in this first embodiment, according to the determination algorithm shown in the flowchart in FIG. 5, the processing of Steps S1 and S2, that is, it is determined whether the switch signal acquired from the host controller specifies the heavy rain mode or not. That is, the CPU 21a of the wiper controller 10a performs the heavy rain mode designation determination process based on a unique operation form of the mist switch provided in the vehicle.

In this designation determination process, the CPU 21a first acquires the switch signal (Step S10). Then, the CPU 21a determines whether the switch signal acquired from the host controller indicates an ON operation of the mist switch or not (Step S11). In the case where the determination in Step S11 is “No”, that is, in the case where the switch signal does not indicate an ON operation of the mist switch, the CPU 21a determines whether the current operation mode is the heavy rain mode or not (Step S12).

Then, in the case where the determination in Step S12 is “No”, that is, in the case where the current operation mode is not the heavy rain mode, the CPU 21a performs a control operation according to the switch signal acquired in Step S10 (Step S13). On the other hand, in the case where the determination in Step S12 is “Yes”, that is, in the case where the current operation mode is the heavy rain mode, the CPU 21a determines whether the switch signal acquired in Step S10 indicates an OFF instruction of the wiper switch or not (Step S14).

Then, in the case where the determination in Step S14 is “No”, that is, in the case where the switch signal does not indicate an OFF instruction of the wiper switch, the CPU 21a performs a control operation according to the switch signal acquired in Step S10 (Step S15). On the other hand, in the case where the determination in Step S14 is “Yes”, that is, in the case where the switch signal indicates an OFF instruction of the wiper switch, the CPU 21a continues the control operation based on the heavy rain mode (Step S16).

On the other hand, in the case where the determination in Step S11 is “Yes”, that is, in the case where the switch signal indicates an ON operation of the mist switch, the CPU 21a counts (measures) the ON time of the mist switch (Step S17). Then, the CPU 21a determines whether the ON time of the mist switch exceeds a threshold value, for example, 3 seconds (Step S18).

Then, in the case where the determination in Step S18 is “No”, that is, in the case where the ON time of the mist switch does not exceed the threshold value, the CPU 21a performs a mist control operation (Step S19). On the other hand, in the case where the determination in Step S18 is “Yes”, that is, in the case where the ON time of the mist switch is equal to or greater than the threshold value, the CPU 21a performs a control operation based on the heavy rain mode (Step S20).

According to this designation determination process for the heavy rain mode, the mist switch generally provided in vehicles is also used for designating the heavy rain mode, thus eliminating the need for a dedicated switch for the heavy rain mode. In a case where a dedicated switch is to be added to the vehicle as additional equipment, the configuration of vehicle switches would increase, potentially making it difficult for the driver to perform sudden operations, but by switching between the normal mist operation and the heavy rain mode based on the length of the ON time of the existing mist switch, it is possible to execute the control operation based on the heavy rain mode without the need to provide a new switch.

### Second Embodiment

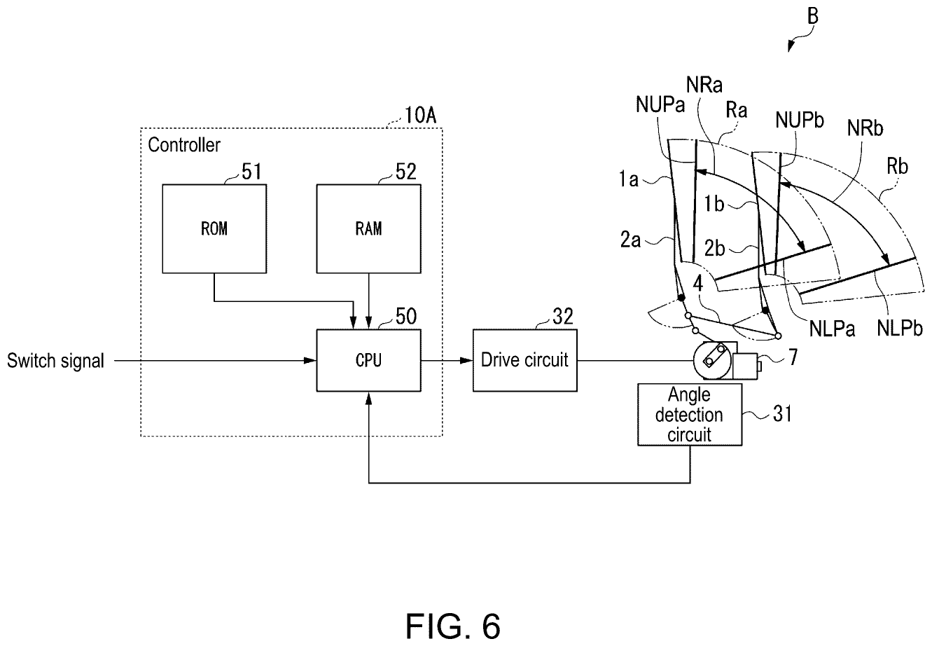

Next, the second embodiment of the present invention is described with reference to FIG. 6. It is noted that in this second embodiment, the same reference numerals are assigned to the same components as in the first embodiment.

The wiping device B according to the second embodiment includes, as shown in FIG. 6, a pair of wiper blades 1a and 1b, a pair of wiper arms 2a and 2b, a link mechanism 4, a motor 7, an angle detection circuit 31, a drive circuit 32, and a controller 10A. Further, the controller 10A includes a CPU 50, a ROM 51, and a RAM 52.

This wiping device B adopts a single-motor drive system that drives a pair of wiper blades 1a and 1b with a single motor 7 (power source) by mechanically connecting the pair of wiper arms 2a and 2b with the link mechanism 4. That is, the wiping device B is provided with one power source, which causes the pair of wiper blades 1a and 1b to perform reciprocating motion. This wiping device B, similar to the wiping device A according to the first embodiment, wipes rainwater from the surface (surface to be wiped) of the vehicle's windshield or rear window.

The link mechanism 4 is a mechanical component that is mechanically connected to the other ends of the pair of wiper arms 2a and 2b, and is also connected to the output shaft of the motor 7. Further, this link mechanism 4 includes a support shaft fixed to the vehicle and is capable of rotating around this support shaft. The motor 7 has its output shaft connected to the link mechanism 4, and by operating the rotation angle of the link mechanism 4, it causes the pair of wiper blades 1a and 1b to swing on the surface to be wiped.

The angle detection circuit 31 has the same function as the pair of angle detection circuits 31a and 31b in the first embodiment, and outputs a relative position signal indicating the amount of movement of either the driver's seat side wiper blade 1a or the passenger seat side wiper blade 1b, proportional to the motor rotation angle of the motor 7. Further, this angle detection circuit 31 outputs an absolute position signal indicating the position of a specific wiper blade among the pair of wiper blades 1a and 1b.

The drive circuit 32 has the same function as the drive circuits 32a and 32b in the first embodiment, and drives the motor 7 based on the drive command input from the drive control unit 51. That is, the drive circuit 32 drives the motor 7 according to the difference between the current rotation number of the motor 7 and the target rotation number TR.

The controller 10A has the same function as the wiper controller 10a in the first embodiment, and includes a normal mode and a heavy rain mode as operation modes. Further, this controller 10A indirectly performs feedback control of the motor 7 by directly controlling the drive circuit 32 with reference to the switch signal input from the host controller.

In this controller 10A, the CPU 50 has the same function as the CPU 21a in the first embodiment, and controls the drive circuit 32 based on the operation map stored in the ROM 23a, the relative position signal and absolute position signal input from the angle detection circuit 31, and the switch signal input from the host control system.

The ROM 52 has the same function as the ROM 23a in the first embodiment, and stores the operation map for normal mode and the operation map for heavy rain mode. The RAM 53 temporarily holds the intermediate data generated by the CPU 50.

In this wiping device B, the normal mode and the heavy rain mode are switched based on the length of the ON time of the mist switch in the switch signal. The wiping range (movement range) of the pair of wiper blades 1a and 1b in the heavy rain mode is set narrower than the wiping range Ra and Rb (movement range) of the pair of wiper blades 1a and 1b in the normal mode. Furthermore, in this wiping device B, the wiping range (movement range) in the heavy rain mode is set to the “minimum wiping area” of the forward visibility as specified by regulations, as shown in FIG. 4.

According to this second embodiment, it is possible to provide a wiping device B that may satisfy the “minimum wiping area” of the forward visibility as specified by regulations during heavy rain. Further, according to the second embodiment, since the wiping range (movement range) in the heavy rain mode is narrower than the wiping range Ra and Rb (movement range) in the normal mode, it is possible to achieve power saving of the wiping device B. In the case of the second embodiment in FIG. 6, the rotational force of one motor 7 is converted into reciprocating swinging of two wiper arms 2a and 2b by the link mechanism 4. In the heavy rain mode, the motor 7 is driven to wipe the narrow wiping range on the driver's seat side to wipe the minimum wiping area NA shown in FIG. 4, and the narrow wiping range on the passenger seat side NRb is driven through the link mechanism 4. This ensures the wiping range for the driver. It is noted that the settings for the top reverse positions NUPa and NUPb and the bottom reverse positions NLPa and NLPb are set similarly to the first embodiment, such as the top reverse position NUP and the bottom reverse position NLP, and the setting of the narrow wiping range NRa for the minimum wiping area NA is set similarly to the first embodiment, such as the first lower side setting position NPA, the second lower side setting position NPB, the second lower side setting position NPC, and the second upper side setting position NPD.

Furthermore, according to the second embodiment, similarly to the first embodiment, the mist switch generally provided in vehicles is also used for designating the heavy rain mode, so a dedicated switch for designating the heavy rain mode is unnecessary. Thus, according to the second embodiment, it is possible to execute control operations based on the heavy rain mode without the need to establish a new switch.

It is noted that the present invention is not limited to the aforementioned embodiments, and various modifications are possible. For example, the block diagrams in FIG. 1 and FIG. 6 are merely examples of control configurations, and various modifications are possible within the scope that does not deviate from the spirit of the present invention.

### REFERENCE SIGNS LIST

1a, 1b . . . Wiper blade, 2a, 2b . . . Wiper arm, 3a, 3b . . . Wiper shaft, 7a, 7b . . . Motor (power source), 10a, 10b . . . Wiper controller (power source drive unit), 21a, 21b . . . CPU, 22a, 22b . . . Communication circuit, 23a, 23b . . . ROM, 24a, 24b . . . RAM, 31a, 31b . . . Angle detection circuit, 32a, 32b . . . Drive circuit

1. A wiping device that wipes rainwater on a surface to be wiped by causing a wiper blade to perform reciprocating motion using a predetermined power source, the wiping device comprising:
a power source drive unit, setting a wiping range of a heavy rain mode to be narrower than a wiping range of a normal mode, and setting the wiping range of the heavy rain mode to a minimum wiping area specified by regulations.

2. The wiping device according to claim 1, wherein the power source drive unit switches an operation mode from the normal mode to the heavy rain mode based on a switch signal of a mist switch provided in a vehicle.

3. The wiping device according to claim 2, wherein the power source drive unit switches the operation mode from the normal mode to the heavy rain mode based on a length of an ON time of the mist switch.

4. The wiping device according to claim 3, wherein the power source drive unit switches from the normal mode to the heavy rain mode in a case where the ON time is equal to or greater than a predetermined threshold value.

5. The wiping device according to claim 1, wherein the power source is provided as one or two, where one power source causes one or a pair of the wiper blades to perform reciprocating motion, and two power sources individually cause a pair of the wiper blades to perform reciprocating motion.

6. The wiping device according to claim 1, wherein the power source comprises a first brushless wiper motor and a second brushless wiper motor, the wiper blade comprises a first wiper blade that performs reciprocating motion by the first brushless wiper motor and a second wiper blade that performs reciprocating motion by the second brushless wiper motor, and in response to a detection of the heavy rain mode, the second brushless wiper motor is stopped, and only the first brushless wiper motor is driven to wipe the minimum wiping area by the first wiper blade.
